(19) United States
(12) Patent Application Publication
(10) Pub. No.: US 2025/0211073 A1
(43) Pub. Date: Jun. 26, 2025

(54) METHOD FOR DETECTING TRANSFER MOLDING PROCESS VARIATIONS FOR A MOTOR ROTOR CORE STACK

(71) Applicant: Ford Global Technologies, LLC, Dearborn, MI (US)

(72) Inventors: Youji Ma, Troy, MI (US); Bryce Andrew Schwager, Ypsilanti, MI (US)

(73) Assignee: Ford Global Technologies, LLC, Dearborn, MI (US)

(21) Appl. No.: 18/390,802

(22) Filed: Dec. 20, 2023

(51) Int. Cl. H02K 15/02

(52) U.S. Cl. CPC H02K 15/02; H02K 2215/00

(57) ABSTRACT

A method to detect variations in a rotor core stack includes measuring a clamp press position of a clamp press and a plunger position of a plunger, determining a nominal position of the clamp press, calculating a height offset of the rotor core stack, calculating a normalized position of the plunger by adding the plunger position and the height offset of the rotor core stack, and analyzing the normalized plunger position to detect variations within the rotor core stack.

### FIELD

The present disclosure relates to electric motors. More specifically, the present disclosure relates to detecting transfer molding process variations for an electric traction motor rotor core stack.

### BACKGROUND

The statements in this section merely provide background information related to the present disclosure and may not constitute prior art.

Electric traction motors are used to provide propulsion in electric vehicles and hybrid electric vehicles. Electric traction motors traditionally include a stationary component, or stator, and a rotating component, or rotor. The rotor includes a rotor core stack and magnets that are inserted into cavities of the rotor core stack. The magnets are sealed in the rotor core stack with thermosetting resin in a resin transfer molding press process.

During the resin transfer molding process, a press clamps a rotor core stack between a mandrel and a runner plate via the bottom of the press and the top of the press. Raw resin is placed in a reservoir located above the runner plate and is heated to a liquid state. A plunger presses the liquid state resin through the runner plate to fill the cavities around the magnets in the rotor core stack. Once the resin is cured to a solid state, the magnets are permanently sealed within the rotor core stack.

There are a variety of situations that can occur during the transfer molding process that may result in defective rotor core stacks. Some situations may include resin leaking, missing magnets, or an incomplete fill. These situations may result in variation in the amount of remnant resin remaining in the reservoir.

The volume of the rotor core stack cavities can also vary between each rotor core stack. The variations in volume of the rotor core stack cavities can cause significant variation in volume of remnant resin. The normal variation in the volume of remnant resin due to variations in volume of the rotor core stack cavities may be larger than the abnormal variations in remnant resin due to process issues.

The present disclosure addresses challenges related to molding process variations in electric motor rotor stacks.

### SUMMARY

This section provides a general summary of the disclosure and is not a comprehensive disclosure of its full scope or all of its features.

In one form of the present disclosure, a method to detect variations in a rotor core stack includes: measuring a clamp press position of a clamp press and a plunger position of a plunger; determining a nominal position of the clamp press; calculating, via a controller, a height offset of the rotor core stack; calculating, via the controller, a normalized position of the plunger by adding the plunger position and the height offset of the rotor core stack; and analyzing, via the controller, the normalized plunger position to detect variations within the rotor core stack, and in response to analyzing the normalized plunger position to detect variations within the rotor core stack, one of accepting or rejecting the rotor core stack for use in production based on the detected variations.

In variations of this method, which may be implemented individually or in combination: calculating the height offset of the rotor core stack further includes calculating a difference between the clamp press position and the nominal position of the clamp press to determine a position difference; calculating the height offset of the rotor core stack further includes normalizing a plunger cross-sectional area of a bore of the plunger by a cross-sectional area of the rotor core stack to determine a normalized area; calculating the height offset of the rotor core stack further includes multiplying the normalized area and the position difference; the cross-sectional area of the rotor core stack is a cross-sectional area of a plurality of cavities of the rotor core stack; analyzing the normalized plunger position further includes determining whether the plunger position and the clamp press position are between an upper bound and a lower bound; analyzing the normalized plunger position further includes accepting the rotor core stack with the plunger position and the clamp press position that are between the upper bound and the lower bound; analyzing the normalized plunger position further includes rejecting the rotor core stack with the plunger position and the clamp press position that are not between the upper bound and the lower bound; the clamp press position of the clamp press is a distance between a top surface of the clamp press and a top surface of a runner plate located on a top surface of the rotor core stack; and the plunger position is a distance between a bottom surface of the plunger and a top surface of a runner plate located on a top surface of the rotor core stack.

In another form, a method to detect variations in a rotor core stack includes: measuring a clamp press position of a clamp press and a plunger position of a plunger; determining a nominal position of the clamp press; calculating, via a controller, a difference between the clamp press position and the nominal position of the clamp press to determine a position difference; normalizing, via the controller, a plunger cross-sectional area of a bore of the plunger by a cross-sectional area of a plurality of cavities of the rotor core stack to determine a normalized area; calculating, via the controller, a height offset of the rotor core stack by multiplying the normalized area and the position difference; calculating, via the controller, a normalized position of the plunger by adding the plunger position and the height offset of the rotor core stack; and analyzing, via the controller, the normalized plunger position to detect variations within the rotor core stack, and in response to analyzing the normalized plunger position to detect variations within the rotor core stack, one of accepting or rejecting the rotor core stack for use in production based on the detected variations.

In variations of this method, which may be implemented individually or in combination: analyzing the normalized plunger position further includes determining whether the normalized plunger position and the clamp press position is between an upper bound and a lower bound; analyzing the normalized plunger position further includes accepting the rotor core stack with the plunger position and the clamp press position that are between the upper bound and the lower bound; analyzing the normalized plunger position further includes rejecting the rotor core stack with the plunger position and the clamp press position that are not between the upper bound and the lower bound; the clamp press position of the clamp press is a distance between a top surface of the clamp press and a top surface of a runner plate located on a top surface of the rotor core stack; and the plunger position is a distance between a bottom surface of the plunger and a top surface of a runner plate located on a top surface of the rotor core stack.

In yet another form of the present disclosure, a system to detect variations in a rotor core stack includes: a rotor core stack; a clamp press disposed beneath a bottom surface of the rotor core stack; a runner plate disposed above a top surface of the rotor core stack; a plunger disposed above the runner plate; at least one sensor to determine a clamp press position of the clamp press and a plunger position of the plunger; and a controller to calculate a height offset of the rotor core stack, determine a normalized position of the plunger from the height offset of the rotor core stack and the plunger position, and analyze the normalized plunger position to detect variations in the rotor core stack.

In variations of this system, which may be implemented individually or in combination: the controller determines whether the normalized plunger position and the clamp press position are between an upper bound and a lower bound; the clamp press position of the clamp press is a distance between a top surface of the clamp press and a top surface of the runner plate; and the plunger position is a distance between a bottom surface of the plunger and a top surface of the runner plate.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 depicts a schematic view of a rotor core stack in a transfer molding press according to the present disclosure;

FIG. 2 depicts a rotor core of the rotor core stack according to FIG. 1;

FIG. 3 depicts a method to detect variations in a rotor core stack according to the present disclosure;

FIG. 4 depicts a method to calculate a height offset of a core stack of the rotor core according to FIG. 3;

FIG. 5 depicts an example dataset of rotor core stacks according to the present disclosure; and

FIG. 6 depicts a method to analyze the normalized plunger position to detect variations in the rotor core according to FIG. 3.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

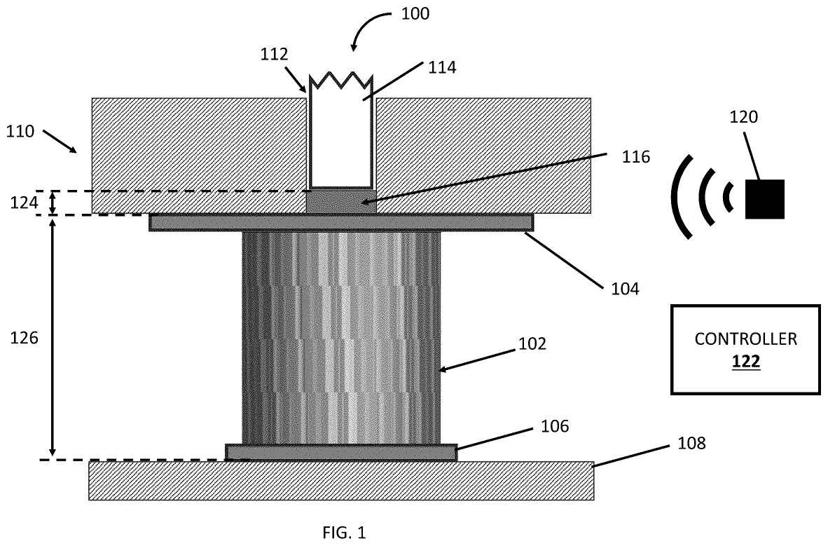

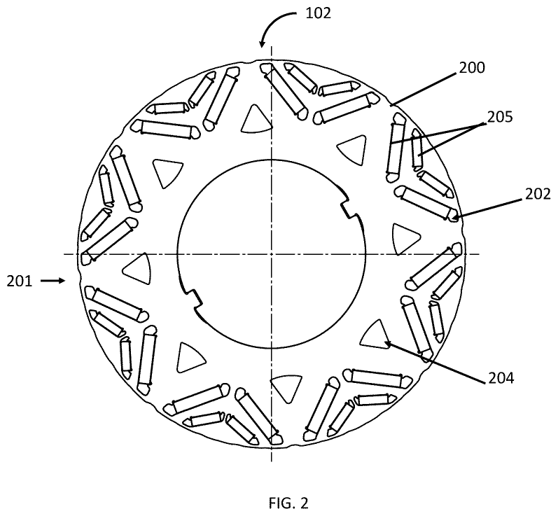

Referring to FIGS. 1 and 2, a transfer molding system 100 includes a rotor core stack 102. The rotor core stack 102 includes a series of rotor core 200 stacked on top one another along a vertical direction. The rotor core stack 102 further includes a plurality of cavities 201 disposed within each of the rotor core 200 of the rotor core stack 102. The cavities 201 include a plurality of magnet slots 202 where a plurality of magnets 205 are disposed. In one form, the cavities 201 of the rotor core stack 102 may also include structural apertures 204.

The transfer molding system 100 further includes a runner plate 104, a mandrel 106, a clamp press 108 and a support member 110. The rotor core stack 102 is disposed between the runner plate 104 and the mandrel 106. The mandrel 106 is disposed on a top surface of the clamp press 108 and the rotor core stack 102 is disposed on a top surface of the mandrel 106. The runner plate is then disposed above the rotor core stack 102 and below the support member 110. During the transfer molding press process, the clamp press 108 moves toward the support member 110 to clamp the rotor core stack 102 between the runner plate 104 and the mandrel 106 with a pre-determined force.

The transfer molding system 100 further includes a plunger 114 disposed within an aperture of the support member 110. The aperture and runner plate 104 define a reservoir 112. A solid polymer is placed within the reservoir 112 and heated until it reaches the liquid state and becomes a liquid polymer 116. In one form, the liquid polymer 116 is an epoxy resin.

During the transfer molding press process the plunger 114 presses the liquid polymer 116 through apertures in the runner plate 104 to fill cavities within the rotor core stack 102. The liquid polymer 116 fills the space between the plurality of magnet slots 202 and the plurality of magnets 205. Once the liquid polymer 116 cures and reaches a solid state, the plurality of magnets 205 are permanently retained within the plurality of magnet slots 202. In one form, the cavities may also include structural apertures 204 that are filled with the liquid polymer 116 to provide structural support to the rotor core stack 102 once the liquid polymer 116 cures.

The transfer molding system 100 further includes at least one sensor 120 and a controller 122. The at least one sensor 120 determines a clamp press position 126 of the clamp press 108 and a plunger position 124 of the plunger 114. The clamp press position 126 provides the location of the clamp press in relation to the rest of the transfer molding system 100. In one form, the clamp press position 126 is the distance between a top surface of the clamp press 108 and a top surface of the runner plate 104. In various forms, the clamp press position 126 is when the clamp press 108 is in the final position that clamps that mandrel 106, the rotor core stack 102, and the runner plate 104 between the clamp press 108 and the support member 110 with a predetermined force. The plunger position 124 provides the location of the plunger in relation to the rest of the transfer molding system 100. In a particular form, the plunger position 124 is a distance between the bottom surface of the plunger 114 and the top surface of the runner plate 104. In one form, the plunger position 124 is when the plunger 114 is in the final position and has finished extruding the liquid polymer 116 into the rotor core stack 102. The sensor 120 conveys the clamp press position 126 and the plunger position 124 to the controller 122.

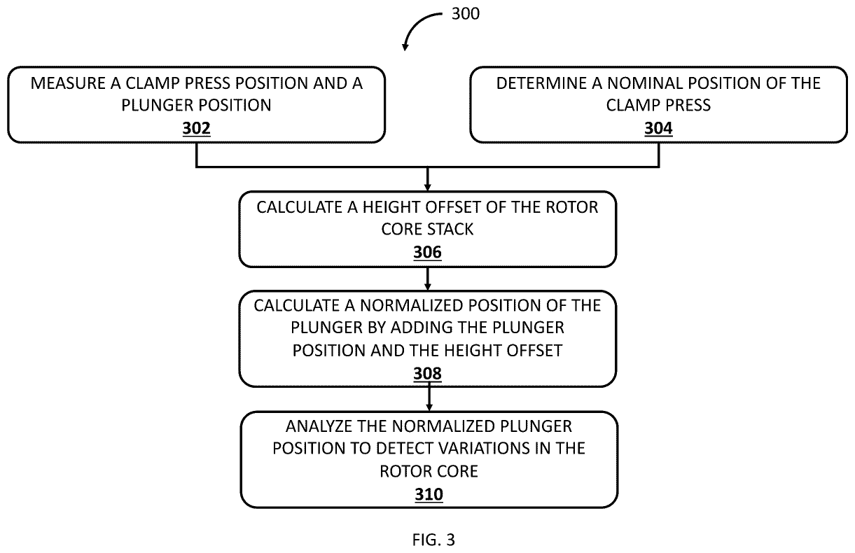

Referring to FIG. 3, a method 300 to detect variations in a rotor core stack 102 is shown. In step 302 the at least one sensor 120 measures the clamp press position 126 and the plunger position 124. In one form, the clamp press position 126 is the final position of the clamp press 108. The final position of the clamp press 108 is when the clamp press 108 clamps the mandrel 106, the rotor core stack 102, and the runner plate 104 between the clamp press 108 and the support member 110 with a predetermined force. In various forms, the plunger position 124 is the final position of the plunger 114. The final position of the plunger 114 is when the plunger 114 is in the final position and has finished extruding the liquid polymer 116 into the rotor core stack 102. In a particular form, the final position of the plunger 114 is variable and is determined based on the transfer molding process for each rotor core stack 102. During the final phase of the transfer molding process, the plunger 114 extrudes the liquid polymer 116 through apertures in the runner plate 104 with a predetermined pressure for a first predetermined duration of time. The plunger 114 is then stopped and held for a second predetermined duration of time while the liquid polymer 116 cures into a solid. The position at which the plunger 114 is stopped is the final position of the plunger 114. In a particular form, the controller 122 records the clamp press position 126 and the plunger position 124.

In step 304, the controller 122 determines a nominal position of the clamp press 108. In one form the nominal position of the clamp press is determined by adding the height of the rotor core stack 102, the runner plate 104, and the mandrel 106. In another form the nominal clamp press position 126a may be an average or mean of a plurality of final positions of the clamp press 108 from a sample data set of previous rotor core stack 102 transfer molding systems 100. In one form, the final clamp press position 126c is the nominal clamp press position 126a. In other forms, the final clamp press position 126c may vary from the nominal clamp press position 126a by a tolerance within a predetermined tolerance range. Step 304 may be completed before, after, or concurrently with step 302. In step 306, the controller 122 calculates a height offset of the rotor core stack 102.

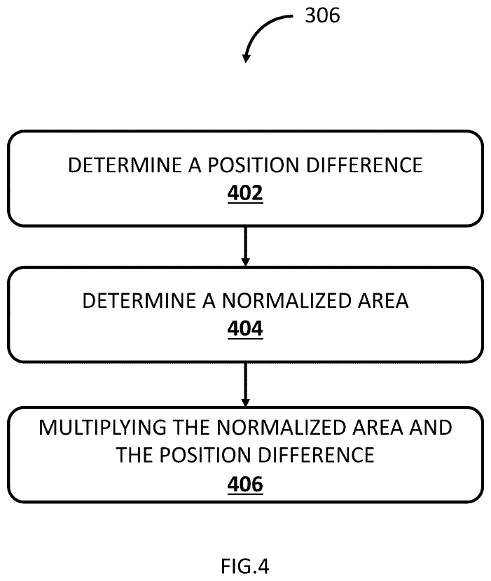

Referring to FIG. 4, further details of step 306 are provided. In step 402 a position difference is determined by subtracting the nominal position of the clamp press 108 from the clamp press position 126. The controller then determines a normalized area in step 404. The normalized area is the cross-sectional area of the rotor core stack 102 divided by the cross-sectional area of the bore of the plunger 114. In one form the cross-sectional area of the rotor core stack 102 is the total cross-sectional area of the cavities 201 of the rotor core stack 102. In one form, the total cross-sectional area of the cavities 201 includes at least one of the total cross-sectional area of the plurality of magnet slots 202 and the total cross-sectional area of the structural apertures 204. In step 406 the normalized area of step 404 is multiplied with the position difference of step 402 to provide the height offset of the rotor core stack 102. The height offset is determined by the below equation:

$$Height Offset = \frac{{A}_{2}}{{A}_{1}} ( {X}_{2} - {\overline{X}}_{2} )$$

Where X₂ is the clamp press position 126, X̅₂̅ is the nominal clamp press position, A₁ is the cross-sectional area of the bore of the plunger 114, and A₂ is the cross-sectional area of the rotor core stack 102.

Referring back to FIG. 3, in step 308 The controller 122 calculates a normalized plunger position of the plunger. The normalized plunger position 124b is the summation of the nominal plunger position 124a and the height offset calculated in step 306. The normalized plunger position 124b is dependent on the geometry of the rotor core stack 102 as it takes the height and cross-sectional area of the cavities 201 of the rotor core stack 102 into account.

Then in step 310 the controller 122 analyzes the normalized plunger position to detect variations in the rotor core stack 102. Common sources for variations in the rotor core stack 102 include variations in the volume of liquid polymer 116, volume of the cavities 201 in the rotor core stack 102, volume of the magnets 205, and volume of the apertures in the runner plate 104. For example, if the rotor core stack 102 is missing a magnet 205, the volume of the total area for the cavities 201 will increase and the amount of liquid polymer 116 required to fill the cavities 201 of the rotor core stack 102 will increase. Other sources for variations in the rotor core stack 102 include resin squeeze out between the rotor cores 200 or runner plate 104, and incomplete transfer of the liquid polymer 116.

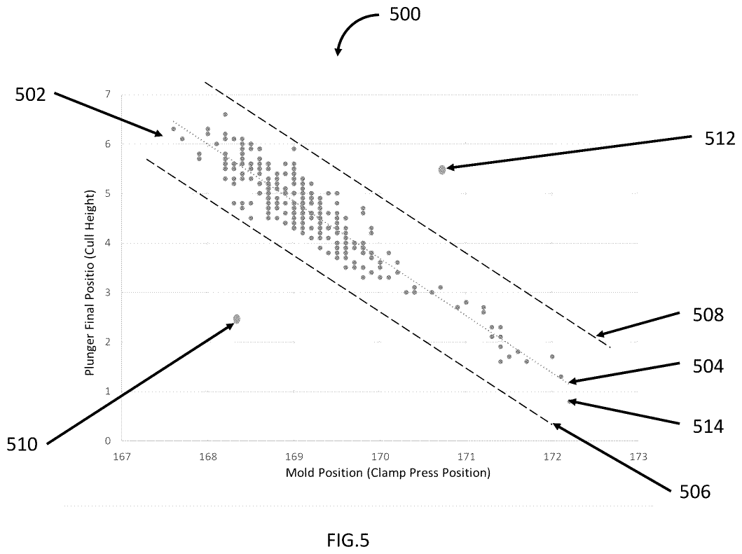

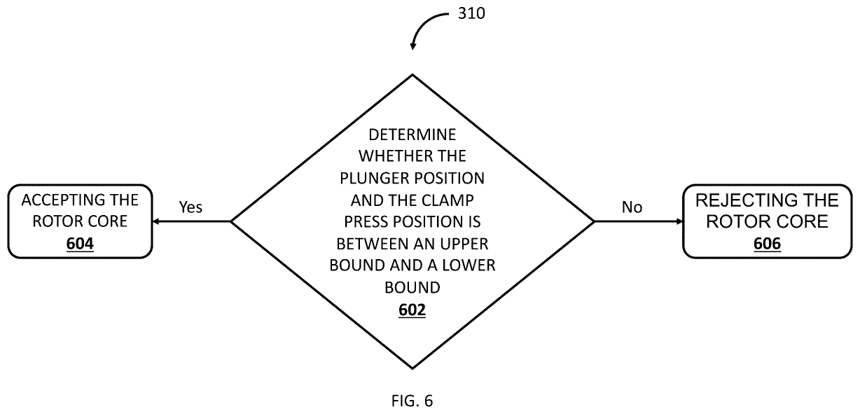

Referring further to FIGS. 5 and 6, a scatter plot 500 aggregates data 502 of a plurality of rotor core stacks 102 in a transfer molding system 100 and correlates the plunger position 124 and the clamp press position 126 of the data 502. In one form, the data 502 include a predetermined set of data from the rotor core stacks 102 of previous transfer molding systems 100. In one variation, the data 502 may be a random sample data from the predetermined set of data. In one form, the predetermined data set may be comprised of data from rotor core stacks 102 of previous transfer molding systems 100 that have previously passed a quality control process. In another form, the data 502 may be a compilation of rotor core stacks 102 to be analyzed for variations.

The normalized plunger position is calculated for each point of the data 502. The aggregation of the normalized plunger positions forms a line 504. In one form, the line 504 is a line of best fit through the data 502 that expresses the relationship between the plunger position 124 and the clamp press position 126 of the plurality of data 502. In one form, the line 504 is linear. The line 504 is dependent on the data 502 and the normalized plunger position. A lower bound 506 and an upper bound 508 is determined based on the line 504. In one form, the lower bound 506 and the upper bound 508 are within a one to five standard deviations of the line 504. In another form the upper bound 508 and the lower bound 506 are within +/− three standard deviations of the line 504 respectfully. As in the upper bound 508 is three standard deviations above than the line 504, and the lower bound 506 is three standard deviations less than the line 504.

In step 602, the controller determines whether the plunger position 124 and the clamp press position 126 are between the upper bound 508 and the lower bound 506. If both the plunger position 124 and the clamp press position 126 are between the upper bound 508 and the lower bound 506 the respective rotor core stack 102 is accepted for use in production in step 604. An example of an accepted rotor core stack 102 is represented by accepted data point 514. If at least one of the plunger positions 124 and the clamp press position 126 are not between the upper bound 508 and the lower bound 506 the respective rotor core stack 102 is rejected for use in production in step 606. An example of a rotor core stack 102 that is rejected due to liquid polymer 116 being squeezed out between the rotor core stack 102 rotor core 200 or the runner plate 104 is represented by rejected data point 510. An example of a rotor core stack 102 that is rejected due to in incomplete transfer of the liquid polymer 116 is represented by rejected data point 512. The method 300 accounts for variations in the height of the rotor core stack 102, and the area of the cavities 201 of the rotor core stack 102 when determining acceptable variations for the rotor core stack 102.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

In this application, the term “controller” and/or “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components (e.g., op amp circuit integrator as part of the heat flux data module) that provide the described functionality; or a combination of some or all of the above, such as in a system-on-chip.

The term memory is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks, flowchart components, and other elements described above serve as software specifications, which can be translated into the computer programs by the routine work of a skilled technician or programmer.

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method to detect variations in a rotor core stack, the method comprising:
measuring a clamp press position of a clamp press and a plunger position of a plunger;
determining a nominal position of the clamp press;
calculating, via a controller, a height offset of the rotor core stack;
calculating, via the controller, a normalized position of the plunger by adding the plunger position and the height offset of the rotor core stack; and
analyzing, via the controller, the normalized plunger position to detect variations within the rotor core stack, and in response to analyzing the normalized plunger position to detect variations within the rotor core stack, one of accepting or rejecting the rotor core stack for use in production based on the detected variations.

2. The method of claim 1, wherein calculating the height offset of the rotor core stack further comprises calculating a difference between the clamp press position and the nominal position of the clamp press to determine a position difference.

3. The method of claim 2, wherein calculating the height offset of the rotor core stack further comprises normalizing a plunger cross-sectional area of a bore of the plunger by a cross-sectional area of the rotor core stack to determine a normalized area.

4. The method of claim 3, wherein calculating the height offset of the rotor core stack further comprises multiplying the normalized area and the position difference.

5. The method of claim 3, wherein the cross-sectional area of the rotor core stack is a cross-sectional area of a plurality of cavities of the rotor core stack.

6. The method of claim 1, wherein analyzing the normalized plunger position further comprises determining whether the plunger position and the clamp press position are between an upper bound and a lower bound.

7. The method of claim 6, wherein analyzing the normalized plunger position further comprises accepting the rotor core stack with the plunger position and the clamp press position that are between the upper bound and the lower bound.

8. The method of claim 6, wherein analyzing the normalized plunger position further comprises rejecting the rotor core stack with the plunger position and the clamp press position that are not between the upper bound and the lower bound.

9. The method of claim 1, wherein the clamp press position of the clamp press is a distance between a top surface of the clamp press and a top surface of a runner plate located on a top surface of the rotor core stack.

10. The method of claim 1, wherein the plunger position is a distance between a bottom surface of the plunger and a top surface of a runner plate located on a top surface of the rotor core stack.

11. A method to detect variations in a rotor core stack, the method comprising:
measuring a clamp press position of a clamp press and a plunger position of a plunger;
determining a nominal position of the clamp press;
calculating, via a controller, a difference between the clamp press position and the nominal position of the clamp press to determine a position difference;
normalizing, via the controller, a plunger cross-sectional area of a bore of the plunger by a cross-sectional area of a plurality of cavities of the rotor core stack to determine a normalized area;
calculating, via the controller, a height offset of the rotor core stack by multiplying the normalized area and the position difference;
calculating, via the controller, a normalized position of the plunger by adding the plunger position and the height offset of the rotor core stack; and
analyzing, via the controller, the normalized plunger position to detect variations within the rotor core stack, and in response to analyzing the normalized plunger position to detect variations within the rotor core stack, one of accepting or rejecting the rotor core stack for use in production based on the detected variations.

12. The method of claim 11, wherein analyzing the normalized plunger position further comprises determining whether the normalized plunger position and the clamp press position is between an upper bound and a lower bound.

13. The method of claim 12, wherein analyzing the normalized plunger position further comprises accepting the rotor core stack with the plunger position and the clamp press position that are between the upper bound and the lower bound.

14. The method of claim 12, wherein analyzing the normalized plunger position further comprises rejecting the rotor core stack with the plunger position and the clamp press position that are not between the upper bound and the lower bound.

15. The method of claim 11, wherein the clamp press position of the clamp press is a distance between a top surface of the clamp press and a top surface of a runner plate located on a top surface of the rotor core stack.

16. The method of claim 11, wherein the plunger position is a distance between a bottom surface of the plunger and a top surface of a runner plate located on a top surface of the rotor core stack.

17. A system to detect variations in a rotor core stack, the system comprising:
a rotor core stack;
a clamp press disposed beneath a bottom surface of the rotor core stack;
a runner plate disposed above a top surface of the rotor core stack;
a plunger disposed above the runner plate;
at least one sensor to determine a clamp press position of the clamp press and a plunger position of the plunger; and
a controller to calculate a height offset of the rotor core stack, determine a normalized position of the plunger from the height offset of the rotor core stack and the plunger position, and analyze the normalized plunger position to detect variations in the rotor core stack.

18. The system of claim 17, wherein the controller determines whether the normalized plunger position and the clamp press position are between an upper bound and a lower bound.

19. The system of claim 17, wherein the clamp press position of the clamp press is a distance between a top surface of the clamp press and a top surface of the runner plate.

20. The system of claim 17, wherein the plunger position is a distance between a bottom surface of the plunger and a top surface of the runner plate.
